(19) United States
(12) Patent Application Publication
(10) Pub. No.: US 2017/0215460 A1
(43) Pub. Date: Aug. 3, 2017

(54) FOOD PRESERVATION WITH AMINO ACIDS

(71) Applicant: UNIVERSITY OF CALCUTTA, Kolkata (IN)

(72) Inventor: Nilanjan DEB, Kolkata (IN)

(73) Assignee: UNIVERSITY OF CALCUTTA, Kolkata (IN)

(21) Appl. No.: 15/423,432

(22) Filed: Feb. 2, 2017

(30) Foreign Application Priority Data
Feb. 3, 2016 (IN) 201631003861

(51) Int. Cl. A23L 3/3463; B65B 7/28; B65B 25/00; B65D 43/02; B65D 81/28

(52) U.S. Cl. CPC A23L 3/3463; B65D 43/0202; B65D 81/28; B65B 25/001; B65B 7/28; A23V 2002/00

(57) ABSTRACT

A method of preserving a harvested cultivated food can include applying a preservative composition onto a cultivated food. The preservative composition can include an amino acid, peptide having the amino acid or protein having the amino acid. The amino acid or peptide or protein having the amino acid can be associated with a water soluble substance. The water soluble substance may facilitate application of the amino acid to the cultivated food and may contribute to the improvement of preservation of the cultivated food post-harvest. A container can be configured for protecting harvested cultivated food by having a chamber with a preservative composition located the container. A substrate can include a preservative composition located on the substrate, which can be applied to a cultivated food to increase preservation.

### RELATED APPLICATION

This application claims priority under 35 U.S.C. §119 of Indian Patent Application No. IN201631003861, filed on Feb. 3, 2016 and entitled “Food Preservation with Amino Acids,” the entire contents of which are hereby incorporated by reference.

### FIELD OF TECHNOLOGY

The field of the technology relates to the use of amino acids (e.g., amino acids associated with a water soluble substance) in food preservation systems and methods.

### BACKGROUND

Even though harvested food preservation techniques have been researched and utilized throughout the duration of humankind, harvested food continues to become spoiled and inedible. Food spoilage may occur at any time during post-harvest handling. The harvested food may become inedible due to over-ripening that may cause bad odors, color change, loss of texture, loss of crispness, loss of flavor, and overall appearance of inedibility. Thus, improvements in food preservation, storage, and shelf life continues to be needed in developing and developed countries regardless of geographical location.

### OBJECT

An object of the technology described herein is to improve the shelf life and preservation of harvested food with systems and methods that utilize amino acids (e.g., amino acids associated with a water soluble substance) to protect the harvested food. The foregoing object is illustrative only and is not intended to be in any way limiting.

### STATEMENT

The technology includes food preservation systems and methods that utilize amino acids (e.g., amino acids associated with a water soluble substance). The food preservation systems can include preservative compositions having amino acids or amino acids associated with water soluble substances, containers to contain harvested food having the preservative compositions, and packages having an interior coated with a preservative composition and containing the harvested food therein. The methods can utilize the food preservation systems for enhancing preservation of harvested food to improve food storage and shelf life. The foregoing statement is illustrative only and is not intended to be in any way limiting.

### SUMMARY

In one embodiment, a method of preserving a harvested cultivated food can include applying a preservative composition onto a cultivated food. The preservative composition can include an amino acid, peptide having the amino acid or protein having the amino acid. The amino acid or peptide or protein having the amino acid can be associated with a water soluble substance. The water soluble substance may facilitate application of the amino acid to the cultivated food and may contribute to the improvement of preservation of the cultivated food post-harvest. The cultivated food can be harvested before, during, or after application of the preservative composition. This can include application of the preservative composition while the cultivated food is still growing on a plant, as the cultivated food is being harvested, or after the cultivated food has been harvested. In some instances, application of the preservative composition at an early stage can prolong the edibility of the food due to improved preservation and shelf life.

In one embodiment, a container can be configured for protecting harvested cultivated food. The container can include a container body defining a chamber and having a removable lid. A preservative composition can be located in the container. The preservative composition can include an amino acid, peptide having the amino acid or protein having the amino acid, where the amino acid can be associated with a water soluble substance. In one aspect, the preservative composition is an aqueous liquid.

In one embodiment, a substrate can be used for protecting harvested cultivated food. The substrate can include a substrate body. A preservative composition can be located on the substrate. The preservative composition can be formulated in accordance with any embodiment described herein. In one aspect, the substrate is a flexible polymeric substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates an embodiment of a food preservation system.

FIG. 2 illustrates another embodiment of a food preservation system.

FIG. 3 illustrates an embodiment of a food preservation package.

FIG. 4 illustrates another embodiment of a food preservation package.

FIG. 5 illustrates an embodiment of a food preservation substrate.

FIG. 6 illustrates another embodiment of a food preservation substrate.

FIG. 7 illustrates an embodiment of food preserved with a food preservation composition.

FIG. 8 illustrates an embodiment of food packaged in a food preservation package.

FIG. 9 illustrates an embodiment of food in a food preservation composition.

FIG. 10 illustrates an embodiment of manufacturing a food preservation substrate.

FIG. 11 illustrates another embodiment of manufacturing a food preservation substrate.

FIG. 12 illustrates an embodiment of a method of applying a preservation composition to a food.

The elements in the figures are arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the technology described herein relates to systems and methods for preservation of cultivated foods, such as fruit, vegetable, nuts, seeds, or the like. The systems and methods may inhibit biological functions that ripen or over-ripen or degrade the cultivated food after harvesting to provide an extended storage and shelf life. The systems and methods may be utilized before, during or after harvesting the cultivated food, and may be utilized during post-harvest packaging. As such, reference herein to a “cultivated food” is meant to describe a fruit, vegetable, nut, or seed, or any other edible plant-based food that is grown and cultivated. A “harvested food” or “harvested cultivated food” refers to a cultivated food that has been harvested. Additionally, reference generically to “food” may be a cultivated food before or after harvesting. Accordingly, the systems and methods may also be used for enhancing the preservation of any cultivated food by the mechanisms described herein, without limitation. Any cultivated food that may need preservation can be preserved with the systems and methods that inhibit biological processes that cause ripening or degradation post harvesting.

The systems and methods described herein can be used for preservation of post-harvest cultivated food in order to increase storage and shelf life, and allow for consumption of cultivated food long after harvesting. The systems and methods may be employed in any geographic area, and may be utilized at any time before, during, and/or after harvesting of the cultivated food. However, it may be beneficial to implement the systems and methods soon after harvesting, which may include such systems being utilized in agricultural areas, such as farms, or in general food storage or shipping plants or operations. The systems and methods may be beneficial in areas that lack standard industrialization and processing of harvested foods, such as in developing countries, and may also be utilized in industrialized regions and implemented in the processing of harvested foods on large scales.

The systems and methods may also be utilized in stores to preserve the harvested foods, and may be included in packaging having the harvested foods. As such, the packaging that utilizes the systems and methods may retain the harvested food in good edible condition after purchase and prior to consumption, and during any transportation or storage thereof. The systems and methods may also be used in homes for increased harvested food preservation and shelf life. The systems and methods may also be adapted to be used for harvested food transportation in instances without traditional refrigeration. An example of a use can include hiking or backpacking, where the systems and methods can preserve the harvested food during such activities for longer preservation without refrigeration. On the other hand, the systems and methods may be practiced in harvested food packaging in refrigerators and possibly in freezers when such cold temperatures do not degrade the harvested food (e.g., seeds or nuts). The harvested food packaging utilizing the systems and methods may be pressurized or at normal (e.g., ambient) pressures or in a vacuum. Accordingly, the systems and methods may be practiced at a range of temperatures and pressures. Thus, the systems and methods can be utilized anywhere for enhanced preservation, storage and shelf life extension of harvested foods.

The systems for preserving foods include the use of a preservative composition that includes an amino acid and a water soluble substance. The amino acid and water soluble substances are described herein. The amino acid may be a single amino acid, a string of the amino acids in a peptide, a peptide having the amino acid, or protein having the amino acid.

The amino acid can be any amino acid. In one aspect, the amino acid is selected from the group consisting of leucine, isoleucine, proline, glycine, valine, and combinations thereof. In one example, the amino acid is leucine.

In one embodiment, the amino acid is leucine. The leucine can be included in a peptide or protein. A peptide or protein having at least one leucine can be used, or a peptide or protein having at least two sequential leucine moieties can be used, wherein the peptide or protein includes a terminal leucine that is coupled with the water soluble sub stance.

The water soluble substance can be any substance that is water soluble and that may be capable of increasing the water solubility of the amino acid. In one aspect, the water soluble substance includes a polymer. The polymer can be selected from the group consisting of polyethylene glycol, hydroxyethyl cellulose, hydroxypropyl cellulose, ethyl cellulose, methylcellulose, ethylmethyl cellulose, carboxymethyl cellulose, hydroxypropyl methyl cellulose, cellulose acetate, cellulose triacetate, cellulose propionate, cellulose acetate butyrate, and combinations thereof. Other similar polymers may also be used that may increase water solubility of the amino acid (e.g., leucine). In one aspect, the polymer is polyethylene glycol.

The water soluble substance may also be a polyol. In one aspect, the polyol can be selected from the group consisting of sorbitol, erythritol, threitol, arabitol, xylitol, ribitol, mannitol, galactitol, fucitol, iditol, inositol, and combinations thereof. Other polyols may be used that increase the solubility of the amino acid.

In one aspect, the amino acid is leucine and the water soluble substance is polyethylene glycol. In one aspect, the preservative composition includes leucine covalently conjugated with polyethylene glycol. For example, the polyethylene glycol can be coupled with the amine group of leucine; however, it may be possible to link the carboxyl group of leucine with a polyethylene glycol. The polyethylene glycol can be polymerized to form the coupling, or the polyethylene glycol can be included with functional groups that react with the amine or carboxyl group of the amino acid (e.g., leucine). Accordingly, the preservative composition can include a peptide or protein having a terminal leucine covalently conjugated with polyethylene glycol. The other water soluble substances may also be covalently conjugated to the leucine similarly to how the polyethylene glycol is covalently conjugated (e.g., to amine or carboxyl group).

The preservative composition may be provided in various forms. In one example, the preservative composition can be provided as the amino acid and water soluble substance in an aqueous solution. In another example, the preservative composition can be dried to remove the water to leave dried amino acid and water soluble substance, such as in the form of a film or coating on the harvested food. In another example, the preservative composition can be milled into a powder. In another example, the preservative composition can be attached to a substrate (e.g., beads, wafers, blocks, ribbons, strands, sheets, films, etc.), such as optionally with an adhesive (e.g., bioadhesive, food-grade adhesive, etc.) when the preservative composition does not stick to the substrate without adhesive. In another example, the preservative composition can be loaded on and/or in a polymeric carrier, such as polymeric beads, ribbons, strands, films, sheets or other substrates, where the polymeric carrier can optionally be porous when embedded therein. In another example, the preservative composition can be loaded onto a hydrogel that is applied to the harvested food. In another example, the preservative composition can be loaded into a porous member, such as a porous substrate (e.g., polymeric substrate). In another example, the preservative composition may be loaded onto a semipermeable member (e.g., polydimethylsiloxane (PDMS), alumina, titania, zirconia, silanized alumina, etc.), such as an oxygen permeable membrane, whether hydrophilic or hydrophobic. In another example, the preservative composition can be loaded onto an oxygen porous membrane, matrix, or film.

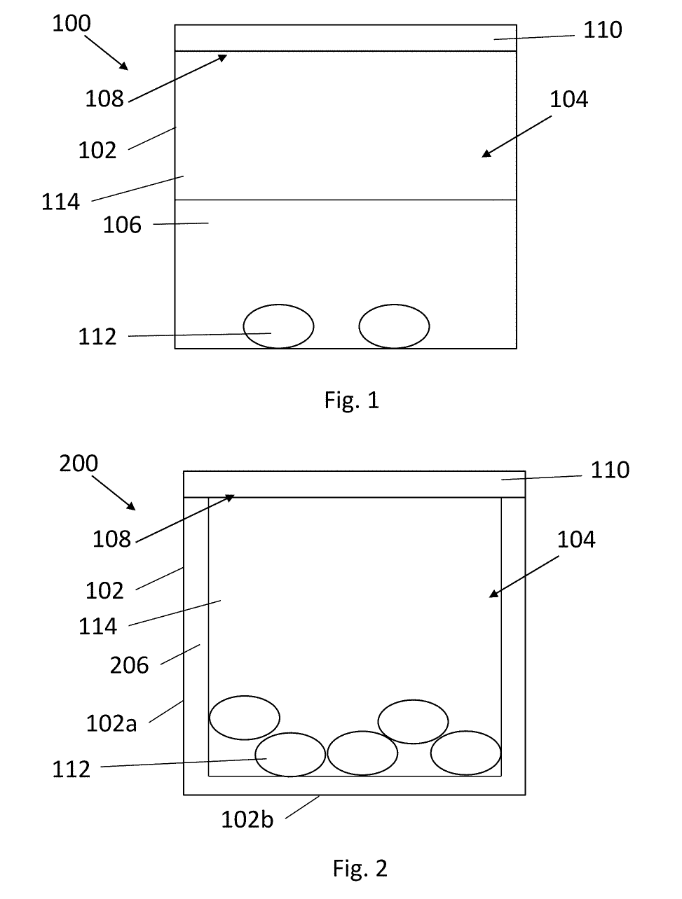

FIG. 1 illustrates an embodiment of a food preservation system 100. The food preservation system 100 can include a container 102 that has an internal chamber 104 having a preservative composition 106 therein. The container can have an opening 108 that can be closed and sealed with a lid 110. The lid 110 can form an airtight coupling with the container 102. The lid 110 can be fit onto the container 102 in any way, such as threading, snap fit, friction fit, or the like. While not shown, a sealing member (e.g., O-ring, gasket, etc.) may be used to enhance the sealing of the lid 110 to the container 102 to form an airtight system in the internal chamber 104. As shown, food 112 is placed in the preservative composition 106 in the internal chamber 104. Here, the preservative composition 106 is flowable, such as a liquid (e.g., aqueous composition) or flowable gel (e.g., thickened aqueous composition) so that the food 112 can be immersed into the preservative composition 106 and extracted therefrom so as to retain some of the preservative composition 106 on surfaces of the food 112. In one example, the preservative composition 106 can be dried and powdered so as to be flowable to also allow immersion of food 112 therein and removal therefrom. A headspace 114 can optionally be included in the container 102 so that the preservative composition 106 has room to be jostled, stirred, or mixed for improving contact with food 112. For example, the food 112 can be filled in the internal chamber 104 above the level of the preservative composition 106, and the container 102 can be shaken so that the preservative composition 106 can contact all of the food 112. Alternatively, the entirety of the internal chamber 104 can be filled with the preservative composition 106. The container 102 may be used for applying the preservative composition 106 to the food, such that either the preservative composition 106 or food 112 is removed from the container 102 after partially or fully coating the food 112 with the preservative composition 106. The container 102 can be reused for coating additional foods with the preservative composition 106, or the container 102 can have the preservative composition 106 removed and the food 112 can be sealed in the container 102 with the lid 110.

FIG. 2 illustrates another embodiment of a food preservation system 200 that includes many of the features of the system 100 of FIG. 1. However, instead of the preservative composition 206 being flowable, it is adherent to the internal surfaces of walls of the internal chamber 104. Accordingly, the preservative composition 206 can be a thick gel, paste, coating, film, or the like that sticks to the walls of the container, such as side walls 102a and/or bottom wall 102b. The internal chamber 104 can include a headspace 114 that can be filed with the food 112. The food 112 can receive the preservative composition 206 by contact therewith. As such, the headspace 114 allows for the container 102 to be shaken so that the food 112 contacts and receives the preservative composition 206.

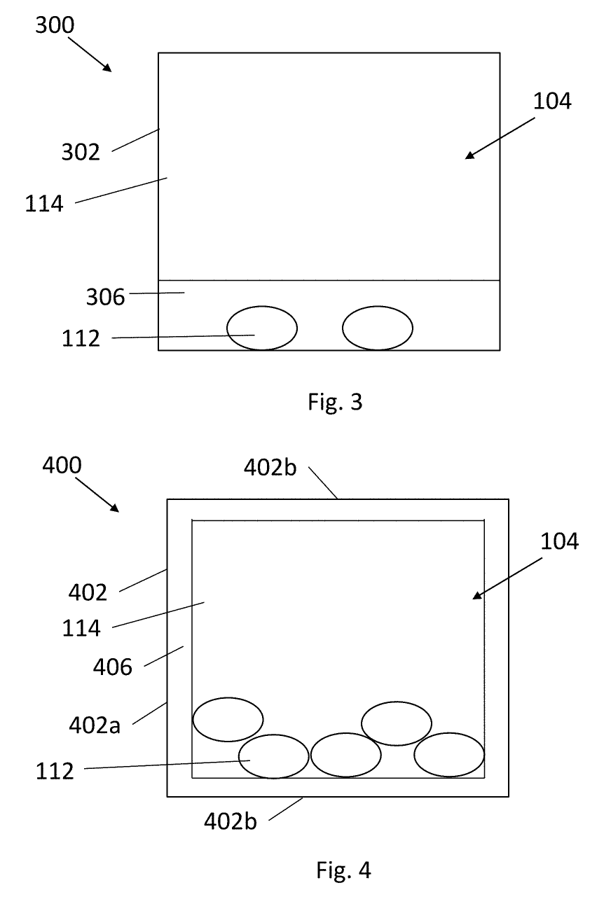

FIG. 3 illustrates an embodiment of a food preservation package 300 that includes many of the features of the system 100 of FIG. 1. However, the container 302 is configured as a package that is completely sealed and omits the opening 108 and lid 110. Also, the container 302 can be flexible, such as a bag. The preservative composition 306 can be flowable as described in connection with FIG. 1. The package configuration of the container 302 can allow for small quantities of the preservative composition 306 to be retained in the internal chamber 104 with the food 112 after being sealed. Accordingly, the preservative composition 306 can be retained with the food 112 during shipping and storage.

FIG. 4 illustrates another embodiment of a food preservation package 400 that includes many of the features of the system 300 of FIG. 3. However, the container 402 (e.g., configured as a flexible package) has the internal walls of the internal chamber 104 coated with the preservative composition 406 similar to FIG. 2. This can include the internal chamber 104 being coated on and between side walls 402a and between end walls 402b. This allows the food 112 to be sealed in the container 402 with the preservative composition 406 for shipping and storage.

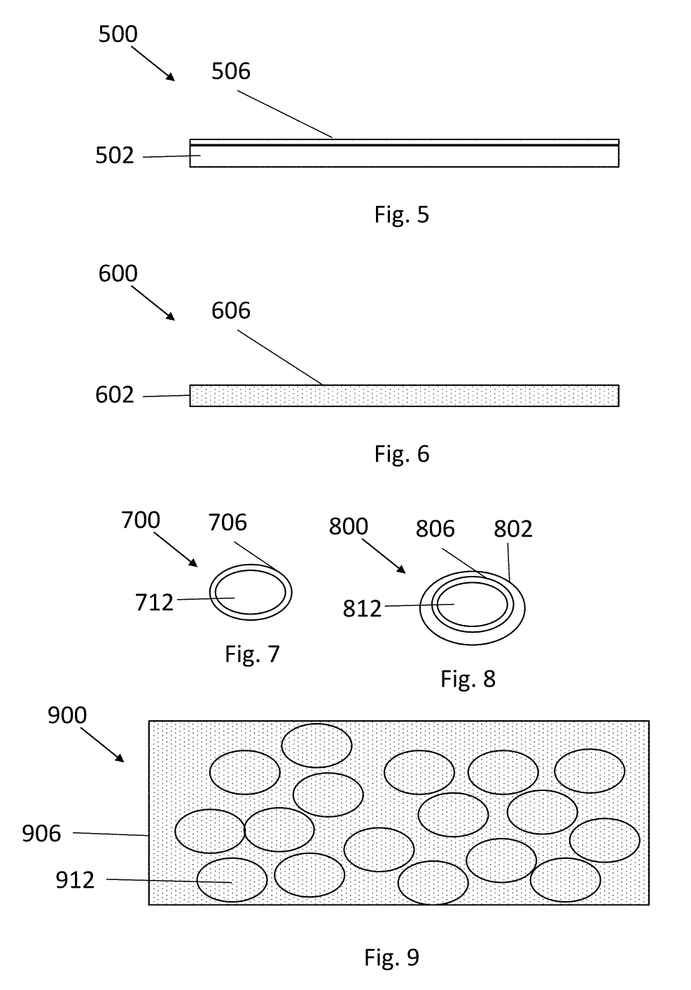

FIG. 5 illustrates an embodiment of a food preservation substrate 500 that includes a substrate 502 having the preservative composition 506 thereon.

FIG. 6 illustrates another embodiment of a food preservation substrate 600 that includes a substrate 602 having the preservative composition 606 therein.

FIG. 7 shows an embodiment of a preserved food 700 having the food 712 coated with the preservative composition 706.

FIG. 8 shows an embodiment of a packaged preserved food 800 having the food 812 fully or partially encapsulated (e.g., airtight or not airtight) with a package 802 having the preservative composition 806 therein such that the food 812 is covered (e.g., partially or fully) with the preservative composition 806.

FIG. 9 shows an embodiment of a preserved food 900 having the food 912 contained in preservative composition 906 such that the food 912 is covered with the preservative composition 906. The preservative composition 906 can be in any form ranging from liquids, gels, hydrogels, pastes, powder, degradable polymer, or the like.

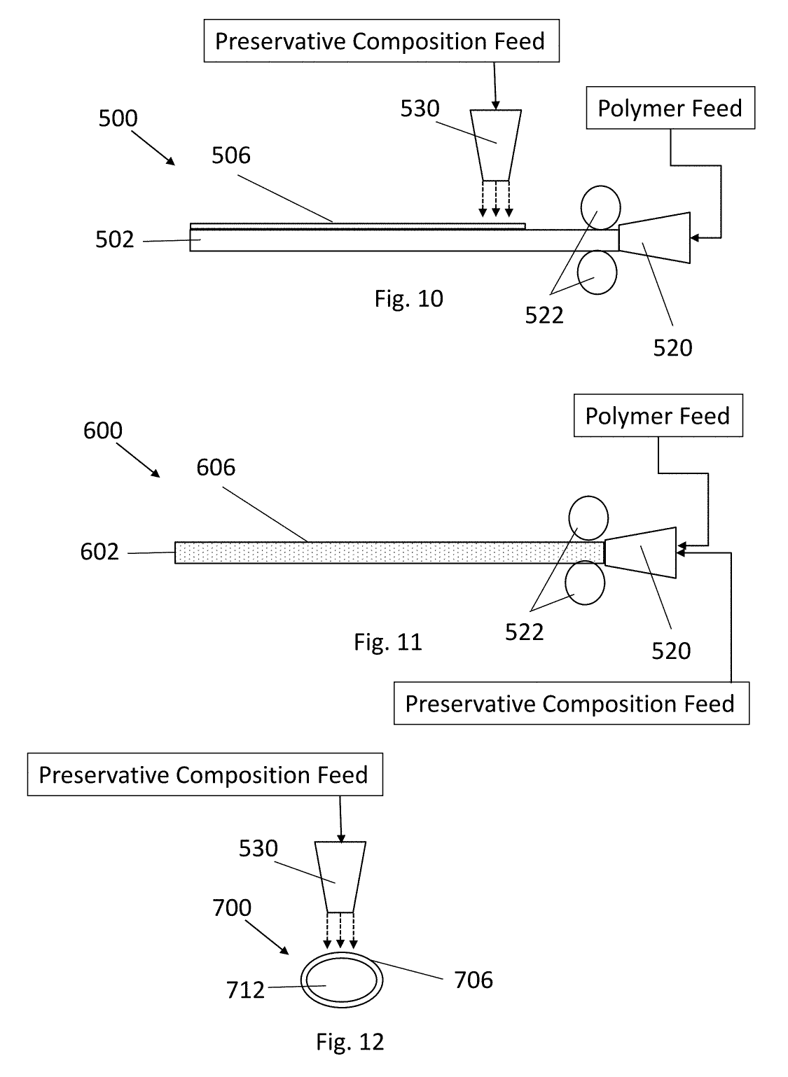

FIG. 10 shows a method of making the food preservation substrate 500 of FIG. 5. As shown, the substrate 502 is formed, such as for example by calendaring a pre-substrate composition (e.g., polymer feed) that is extruded by a die 520. The calendaring is performed by rollers 522. After forming the substrate 502, a sprayer 530 can spray the preservative composition 506 onto the substrate 502. While only one surface is shown to be coated with the preservative composition 506, all surfaces of the substrate 502 may be coated.

FIG. 11 shows a method of making the food preservation substrate 600 of FIG. 6. As shown, the substrate 602 having the preservative composition 606 therein is formed, such as for example by calendaring a mixture (e.g., polymer feed and preservative composition feed) that is extruded by a die 520. The calendaring is performed by rollers 522.

FIG. 12 shows a method of making the preserved food 700 of FIG. 7. As shown, a sprayer 530 can spray the preservative composition 706 onto the food 712.

In one embodiment, a container can be configured for protecting harvested cultivated food. As such, the container can include a removable lid that allows the harvested cultivated food to be introduced therein and removed therefrom. A preservative composition can also be in the container. The preservative composition can include an amino acid, peptide having the amino acid or protein having the amino acid. The amino acid can be associated with a water soluble substance. The preservative composition can be formulated as described herein. In one non-limiting example, the preservative composition is an aqueous liquid; however, other forms of the preservative composition can be used.

In one embodiment, a substrate can be configured for protecting harvested cultivated food. The substrate can include a preservative composition on one or more surfaces of the substrate. The preservative composition can include an amino acid, peptide having the amino acid or protein having the amino acid. The amino acid can be associated with a water soluble substance. In one non-limiting example, the substrate is a flexible polymeric substrate; however, other forms of the substrate can be used.

In one embodiment, a method of preserving a harvested cultivated food can be implemented, such as with the preservative compositions and systems described herein. The method can include applying a preservative composition onto a cultivated food. The preservative composition can be formulated as described herein. The method can also include harvesting the cultivated food, or obtaining the harvested cultivated food post-harvest. The application of the preservative composition to the cultivated food can be performed prior to harvesting, during harvesting, or after harvesting the cultivated food.

The preservative composition can be provided in various forms. In one aspect, the preservative composition includes the amino acid covalently conjugated to the water soluble substance. The conjugation often is at the amine of the amino acid via conjugation chemistry for most of the water soluble substances. However, there may be instances where the water soluble substance conjugates to the carboxyl group of the amino acid. In another aspect, the amino acid is ionically associated with an ionic water soluble substance. In another aspect, the amino acid and water soluble substance can be associated by hydrophobic forces, Van Der Waals, or other forces. The water soluble substance may be a linear polymer or polyol that has one end coupled to the amino acid. The water soluble substance may also be a matrix that contains the amino acid or any number of amino acids, such as by covalent coupling or other association or encapsulation.

The method of preserving the harvested cultivated food can be used for further extending the duration of edibility of the food. The preservation can inhibit biological processes that cause the food to ripen and then degrade after harvesting. As such, the method can include applying a sufficient amount of the preservative composition to improve the storability and shelf life after harvesting. Such improvement may be obtained by inhibiting one or more of the following: ripening of the cultivated food after the harvesting; degradation of the cultivated food after the harvesting; pectin degradation in the cultivated food after the harvesting; production of ethylene in the cultivated food after the harvesting; or polygalacturonase activity in the cultivated food after the harvesting.

In one embodiment, the method of preserving the cultivated food can include dipping the cultivated food into the preservative composition or spraying the cultivated food with the preservative composition. This can include the preservative composition being a fluid or flowable composition, such as a liquid. However, gelatinous or thickened liquids may also be used. Powdered preservative compositions may also be used for dipping or spraying. In one aspect, the cultivated food may first be subjected to a water treatment to moisten the outside surfaces, and then the preservative composition can be applied thereto.

In one embodiment, the method of preserving the cultivated food can include storing the harvested cultivated food having the preservative composition thereon. The storage can be at any temperature, at any humidity, for any duration, whether in an airtight container or package or being exposed to ambient conditions. In one example, the storage can be outdoors with temperatures that range from day temperatures to night temperatures (e.g., below 40° C.), which may vary with climate and season. In another example, the storage can be indoors at room temperature (e.g., 20° C. to 30° C.). In another example, the storage can be in a refrigerator unit (e.g., 0° C. to 20° C.). During winter in cold climates, the food may be heated during storage or transportation so as to be within the aforementioned temperature ranges.

In one embodiment, the method of preserving the cultivated food can include placing the harvested cultivated food into a container, and sealing the container containing the harvested cultivated food having the preservative composition. The container can be a rigid or flexible container with or without a re-sealable opening. The preservative composition can be applied before, during or after introducing the harvested cultivated food therein.

In one embodiment, the method of preserving the cultivated food can include providing a substrate having the preservative composition thereon, and applying the substrate to the cultivated food so that the preservative composition is applied to the cultivated food. The substrate can be in any form, from flexible to rigid. The substrate may also be part of a flexible package or rigid container, such as a wall thereof. The food may also be wrapped or encapsulated in the substrate. For example, the method can include placing the harvested cultivated food in a package that includes the substrate having the preservative composition thereon, and packaging the harvested cultivated food having the preservative composition in the package. In another example, the method can include encapsulating the harvested cultivated food in the substrate. Thus, the substrate can be used in any manner to apply the preservative composition to the cultivated food.

All experiments described herein proved that PEGylated amino acids (e.g., leucine) can be used for improving the preservation of fruits, vegetables and other perishable agricultural products. PEGylated leucine is found to be highly water soluble. It is known that L-leucine has very low water solubility. The use of PEGylated leucine was found to be 2-10 times more efficient in preserving harvested foods than only L-leucine treatment. All treated fruits and vegetables showed considerable increase in shelf life at ambient temperatures when treated with the PEGylated leucine. The preservation was enhanced even at outside temperatures between 36-40° C., and at room temperatures of 32-35° C.) with a relative humidity close to 80%. Treatment with PEGylated leucine also showed increased shelf life of fruits and vegetables at cooler temperatures (e.g., 0° C. to 20° C.) using a commercially available refrigerator. The preservation maintained high quality harvested food without loss of its natural texture, freshness, flavor, taste and nutritional values.

The food preservation techniques described herein can be used with present day packaging materials. In one example, a polymeric food wrapper (e.g., polypropylene) can be coated with the PEGylated leucine, and then shrink-wrapped onto the harvested food. The PEGylated leucine has thermal stability that allows such shrink-wrapping. The shrink wrapping allows the PEGylated leucine to come in contact with the harvested food.

Accordingly, the PEGylated leucine can be a single amino acid, or in a peptide or protein that has leucine, leucine rich repeats, or other amino acids. As such, peptides or proteins that have leucine rich repeats, such as polygalacturonase inhibitor proteins or other similar enzyme inhibitor proteins, can be used.

In one embodiment, the preservation composition can be used for all fruits (e.g., climacteric and non-climacteric) and vegetables. In part, such use can be beneficial because the preservation composition can inhibit polygalacturonase enzymes that degrade cell walls, and thereby protect cell walls from degradation. The preservation composition can inhibit proteolytic degradation of the food. The enzyme inhibition or inhibited proteolytic degradation can inhibit the ripening process. As such, the preserved food can retain a suitable appearance, texture, taste, flavor, aroma, and nutritive value during storage. The preserved cell walls may also inhibit microbial infestations, such as from bacteria and fungi, in part by retaining the surface of the food in good condition so that it can naturally protect against microbes.

In one embodiment, the food preservation may be achieved with a polymeric barrier (e.g., from the PEG or celluloses) to prevent oxygen diffusion and moisture loss that may degrade the food. The polymeric barrier may also help maintain the cell turgor pressure in treated fruit and vegetables. The polymeric barrier can include the amino acid with or without the water soluble substance.

In one embodiment, the PEGylated leucine can improve the retention of the leucine on the surface of the food as well as improve translocation of the leucine into the food. This can inhibit the leucine from being wiped or otherwise removed from the food.

### EXPERIMENTAL

Synthesis of PEGylated leucine was performed. The synthesis included 20 mL polyethylene glycol 400 MW being introduced into a conical flask, and 1 g L-leucine was added with 20 mL mili Q water, while vigorously stirring. About 2 mL dichloromethane was added as a PEGylation activator to the stirred solution, and heated up to 100° C. continuously for 30 minutes on a magnetic stirrer. After the PEGylation was complete, soluble material was filtered, and PEGylated leucine was placed in a separate conical flask. The PEGylated leucine was stored in a bottle.

During synthesis, the first step of the PEGylation can include suitable functionalization of the PEG polymer at one or both terminals. The chemically active or activated derivatives of the PEG polymer are prepared to attach the PEG to the desired L-leucine molecule or other amino acid. As such, a single PEG may have one or two amino acid moieties attached at the ends. The overall PEGylation processes is a solution phase process. UV Vis analysis was performed to confirm the formation of PEGylated leucine.

Additionally, other synthesis techniques can be performed. Ethylene oxide in water and leucine can be heat polymerized in the presence of NaOH catalyst. The reaction can be performed at about 60° C. with a large excess of water. The reaction can be summarized as follows:

n*(CH₂CH₂)O+H₂O+leucine→HO—(—CH₂CH₂—O—)ₙ-H+leucine→PEGylated leucine

Alternatively, PEGylated leucine can be produced from ethylene glycol oligomers and leucine in presence of alkaline (e.g., NaOH) catalyst as summarized as follows:

HOCH₂CH₂OH+n(CH₂CH₂O)+leucine→HO(CH₂CH₂O)ₙ₊₁H+leucine→PEGylated leucine

The experiments showed that both climacteric and non-climacteric fruits retained freshness at normal room temperatures (e.g., up to 35° C. during summer) for up to several weeks using the PEGylated leucine. Fruits and vegetables were externally treated with PEGylated leucine. As a result, the treated fruits and vegetables had improved cell walls without degradation. It is thought that the cell walls are retained without degradation because pectin in the cell wall is protected by inhibiting polygalacturonase enzyme activity. Inhibiting polygalacturonase enzyme activity may inhibit ripening and over-ripening, and thereby inhibit degradation of the harvested food. This may also protect the treated food from microbial infestation because cell wall pectin in harvested fruits and vegetable is thought to be attacked by polygalacturonases that are produced by various fungi and bacterial pathogens. Accordingly, inhibiting polygalacturonase enzymatic action can increase preservation.

The data suggests that leucine may facilitate polygalacturonase inhibition. When fruits or vegetables are treated with leucine, polygalacturonase activity is inhibited and the degradation of cell wall pectin is inhibited. It is also possible that the leucine may facilitate enhanced production or activity of polygalacturonase inhibitor protein (PGIP) of harvested foods. The PGIP can inhibit polygalacturonase, and thereby may inhibit pectin degradation in cell walls of the harvested food. Additionally, it is possible that the leucine may inhibit ethylene production in the treated harvested food.

Different methods of treatment and packaging were studied. Harvested fresh fruits and vegetables can be soaked in 0.1-1% PEGylated leucine aqueous solution for 5-10 minutes in a container. The soaked fruits and vegetables can be air dried in absence of direct sunlight for a few minutes to remove any water. Then, the fruits and vegetables are packed in polyethylene packages for storage and transportation at normal temperatures. The freshness, natural texture, crispness, aroma and taste is retained for a long period without any undesirable change. Treated fruits and vegetables stored at low temperatures in a refrigerator can further increase the shelf life.

Harvested fresh fruits and vegetables were heaped and 0.1-1% PEGylated leucine aqueous solution can be sprayed while rotating fruits and vegetables to spray all fruits and vegetables. The sprayed fruits and vegetables can be air dried for few minutes and packed in a polyethylene container for storage and transportation at normal temperatures. The freshness, natural texture, crispness, aroma and taste is retained for a long period without any undesirable change. Treated fruits and vegetables stored at low temperatures in a refrigerator can further increase the shelf life.

At the pre-harvest stage, an aqueous solution of PEGylated leucine having 1 gram diluted PEGylated leucine per liter of water may be sprayed on the fruits just 1-2 days before harvesting. Such spraying will increase the storability of the fruits after harvesting. The pre-harvest spraying of cultivated food may induce more polygalacturonase inhibitor protein (PGIP) synthesis and accumulation of PGIP in the fruits, particularly in the middle lamella region of cell walls of ripening fruits. Both climacteric and non-climacteric fruits gave good response after spraying with the preservative composition a few days before harvesting.

PEGylated leucine treatment was performed on a banana having a green peel and compared to an untreated control (e.g., water). After 3 days at room temperature, the treated banana was significantly less brown and fresh inside than the untreated control, which was browned and rotten inside.

PEGylated leucine treatment was performed on a green unripe guava and compared to an untreated control (e.g., water). After 3 days at room temperature, the treated guava was still green and unripe, while the untreated guava was ripe and yellowish green. After 7 days at room temperature, the treated guava was ripe, while the untreated guava was over-ripe, soft, disfigured and appeared to be rotting.

PEGylated leucine treatment was performed on a cucumber and compared to a control. After 3 days at room temperature, the treated cucumber was fresh, while the untreated cucumber had shriveled and look to be rotting.

PEGylated leucine treatment was performed on a tomato and compared to an untreated control. After 5 days at room temperature, the treated tomato appeared fresh and edible, while the untreated tomato had defects and looked to have a fungal infection.

The method of treatment and packaging of the tomato with PEGylated leucine can be performed to keep any cultivated food fresh for weeks even at normal temperatures, or for months at cooler temperatures. For example, the preservative composition can be prepared by adding 1 mL PEGylated leucine to 100 mL water. The tomato can be kept in the PEGylated leucine aqueous solution for 30 minutes, and then the treated tomato can be dried in shade to remove adhered water from the surface. The tomato can be placed inside a container, which is then closed and sealed. This process can retain freshness of cultivated foods for weeks at normal temperature, and months at cooler temperature (e.g., in refrigerator).

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method of preserving a harvested cultivated food, the method comprising:
applying a preservative composition onto a cultivated food, the preservative composition including an amino acid, a peptide having the amino acid, or a protein having the amino acid, the amino acid being associated with a water soluble substance.

2. The method of claim 1, wherein the preservative composition includes the amino acid covalently conjugated to the water soluble substance.

3. The method of claim 1, wherein the amino acid is selected from the group consisting of leucine, isoleucine, proline, glycine, valine, and combinations thereof.

4. The method of claim 1, wherein the water soluble substance includes a polymer selected from the group consisting of polyethylene glycol, hydroxyethyl cellulose, hydroxypropyl cellulose, ethyl cellulose, methylcellulose, ethylmethyl cellulose, hydroxypropyl methyl cellulose, cellulose acetate, cellulose triacetate, cellulose propionate, cellulose acetate butyrate, and combinations thereof.

5. The method of claim 4, wherein the water soluble substance includes polyethylene glycol.

6. The method of claim 1, wherein the water soluble substance includes a polyol selected from the group consisting of sorbitol, erythritol, threitol, arabitol, xylitol, ribitol, mannitol, galactitol, fucitol, iditol, inositol, and combinations thereof.

7. The method of claim 1, wherein the preservative composition includes leucine covalently conjugated with polyethylene glycol, a peptide having a leucine covalently conjugated with polyethylene glycol, or a protein having a leucine covalently conjugated with polyethylene glycol.

8. The method of claim 1, further comprising applying a sufficient amount of the preservative composition to:
inhibit ripening of the cultivated food after harvesting the cultivated food;
inhibit degradation of the cultivated food after harvesting the cultivated food;
inhibit pectin degradation in the cultivated food after harvesting the cultivated food;
inhibit production of ethylene in the cultivated food after harvesting the cultivated food; or
inhibit polygalacturonase activity in the cultivated food after harvesting the cultivated food.

9. The method of claim 1, further comprising applying the preservative composition prior to harvesting the cultivated food, during harvesting the cultivated food, or after harvesting the cultivated food.

10. The method of claim 1, the applying comprising dipping the cultivated food into the preservative composition or spraying the cultivated food with the preservative composition.

11. The method of claim 1, further comprising storing the cultivated food having the preservative composition thereon.

12. The method of claim 11, further comprising refrigerating the cultivated food having the preservative composition.

13. The method of claim 1, further comprising:
placing the cultivated food into a container; and
sealing the container containing the cultivated food having the preservative composition.

14. The method of claim 1, further comprising:
providing a substrate having the preservative composition thereon; and
applying the substrate to the cultivated food so that the preservative composition is applied to the cultivated food.

15. The method of claim 14, further comprising:
placing the cultivated food in a package that includes the substrate having the preservative composition thereon; and
packaging the harvested cultivated food having the preservative composition in the package.

16. The method of claim 14, further comprising encapsulating the cultivated food in the substrate.

17. A container for protecting harvested cultivated food, the container comprising:
a removable lid; and
a preservative composition in the container, the preservative composition including an amino acid, a peptide having the amino acid, or a protein having the amino acid, the amino acid being associated with a water soluble substance.

18. The container of claim 17, wherein the preservative composition is an aqueous liquid.

19. A substrate for protecting harvested cultivated food, the substrate comprising:
a preservative composition on the substrate, the preservative composition including an amino acid, a peptide having the amino acid, or a protein having the amino acid, the amino acid being associated with a water soluble substance.

20. The substrate of claim 19, wherein the substrate is a flexible polymeric substrate.
